(19) United States
(12) Patent Application Publication
(10) Pub. No.: US 2003/0101158 A1
(43) Pub. Date: May 29, 2003

(54) Mechanism for managing incoming data messages in a cluster

(76) Inventors: Oscar P. Pinto, Beaverton, OR (US); Rajesh R. Shah, Portland, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/994,779

(22) Filed: Nov. 28, 2001

(51) Int. Cl. G06F 7/00

(52) U.S. Cl. 707/1

(57) ABSTRACT

A mechanism is provided at a host node to determine the optimal number of receive buffers to post for entities (clients) in order to receive incoming data messages in a switched fabric for scalable solutions.

### TECHNICAL FIELD

The present invention relates to data transfer interface technology in a data network, and more particularly, relates to a mechanism for managing queue pairs (QPs) in a host to handle incoming data messages in a cluster.

### BACKGROUND

As high-speed and high-performance communications become necessary for many applications such as data warehousing, decision support, mail and messaging, and transaction processing applications, a clustering technology has been adopted to provide availability and scalability for these applications. A cluster is a group of one or more host systems (e.g., computers, servers and workstations), input/output (I/O) units which contain one or more I/O controllers (e.g. SCSI adapters, network adapters etc.) and switches that are linked together by an interconnection fabric to operate as a single data network to deliver high performance, low latency, and high reliability. Clustering offers three primary benefits: scalability, availability, and manageability. Scalability is obtained by allowing servers and/or workstations to work together and to allow additional services to be added for increased processing as needed. The cluster combines the processing power of all servers within the cluster to run a single logical application (such as a database server). Availability is obtained by allowing servers to “back each other up” in the case of failure. Likewise, manageability is obtained by allowing the cluster to be utilized as a single, unified computer resource, that is, the user sees the entire cluster (rather than any individual server) as the provider of services and applications.

Emerging network technologies for linking servers, workstations and network-connected storage devices within a cluster include InfiniBand™ and its predecessor, Next Generation I/O (NGIO) which have been recently developed by Intel Corp. and other companies to provide a standard-based I/O platform that uses a channel oriented, switched fabric and separate I/O channels to meet the growing needs of I/O reliability, scalability and performance on commercial high-volume servers, as set forth in the “Next Generation Input/Output (NGIO) Specification,” NGIO Forum on Jul. 20, 1999 and the “InfiniBand™ Architecture Specification,” Revision 1, the InfiniBand™ Trade Association on Jun. 19, 2001.

One major challenge to implementing clusters based on NGIO/InfiniBand™ technology is to ensure that data messages traverse reliably between given ports of a data transmitter (source node) and a data receiver (destination node), via one or more given transmission links of a switched fabric data network. Work queues formed in pairs for a certain class of operation, known as a queue pair (QP), are typically utilized at an interface mechanism, known as channel adapter (CA), to process work requests (i.e., message send/receive operations and remote direct memory access “RDMA” read/write operations) posted from clients to describe data movement operation and location of data to be moved for processing and/or transportation via a switched fabric data network. Any time an incoming data message arrives at a queue pair (QP), a receive buffer must be posted for that data message. However, if there is no receive buffer posted at the queue pair (QP), the incoming data message is dropped and retry is required. As a result, Infiniband™ clusters can suffer a lot of wasted bandwidth, congestions and high message processing times due to message drops and retries.

Currently, there is no way for the channel adapter (CA) to identify incoming traffic pattern in a switched fabric data network, nor is there an existing defined by the InfiniBand™ Architecture Specification set forth on Jun. 19, 2001 to optimize on queue pair (QP) receives in a switched fabric data network.

Accordingly, there is a need for a more efficient mechanism to optimize on queue pair (QP) receives to handle incoming traffic pattern with fewer dropped messages in a switched fabric data network so as to reduce fabric bandwidth required for management traffic, fabric congestion and overhead required in processing dropped messages.

### BRIEF DESCRIPTION OF THE DRAWINGS

A more complete appreciation of exemplary embodiments of the present invention, and many of the attendant advantages of the present invention, will become readily apparent as the same becomes better understood by reference to the following detailed description when considered in conjunction with the accompanying drawings in which like reference symbols indicate the same or similar components, wherein:

FIG. 1 illustrates a simple data network having several interconnected nodes for data communications according to an embodiment of the present invention;

FIG. 2 illustrates another example data network having several nodes interconnected by corresponding links of a multi-stage switched fabric according to an embodiment of the present invention;

FIG. 3 illustrates an example packet of data messages transmitted from a source node (data transmitter) to a destination node (data receiver) in an example data network according to an embodiment of the present invention;

FIG. 4 illustrates an example channel adapter installed in a host system to support data transfers via a switched fabric according to an embodiment of the present invention;

FIG. 5 illustrates an example InfiniBand™ Architecture (IBA) subnet including switches, routers and channel adapters installed at respective end nodes according to an embodiment of the present invention;

FIG. 6 illustrates an example of multiple datagram messages arrive at an end node in an example IBA subnet according to an embodiment of the present invention;

FIG. 7 illustrates an example overview of management agents in an example IBA subnet according to an embodiment of the present invention; and

FIG. 8 illustrates an example procedure executed by a General Services Agent (GSA) or a Subnet Management Agent (SMA) in response to incoming data messages at an end node of an example IBA subnet according to an embodiment of the present invention.

### DETAILED DESCRIPTION

The present invention is applicable for use with all types of data networks, I/O hardware adapters and chipsets, including follow-on chip designs which link together end stations such as computers, servers, peripherals, storage subsystems, and communication devices for data communications. Examples of such data networks may include a local area network (LAN), a wide area network (WAN), a campus area network (CAN), a metropolitan area network (MAN), a global area network (GAN), a wireless personal area network (WPAN), and a system area network (SAN), including newly developed computer networks using Next Generation I/O (NGIO), Future I/O (FIO), InfiniBand™ and Server Net and those networks including channel-based, switched fabric architectures which may become available as computer technology advances to provide scalable performance. LAN systems may include Ethernet, FDDI (Fiber Distributed Data Interface) Token Ring LAN, Asynchronous Transfer Mode (ATM) LAN, Fiber Channel, and Wireless LAN. However, for the sake of simplicity, discussions will concentrate mainly on a host system including one or more hardware fabric adapters for providing physical links for channel connections in a simple data network having several example nodes (e.g., computers, servers and I/O units) interconnected by corresponding links and switches, although the scope of the present invention is not limited thereto.

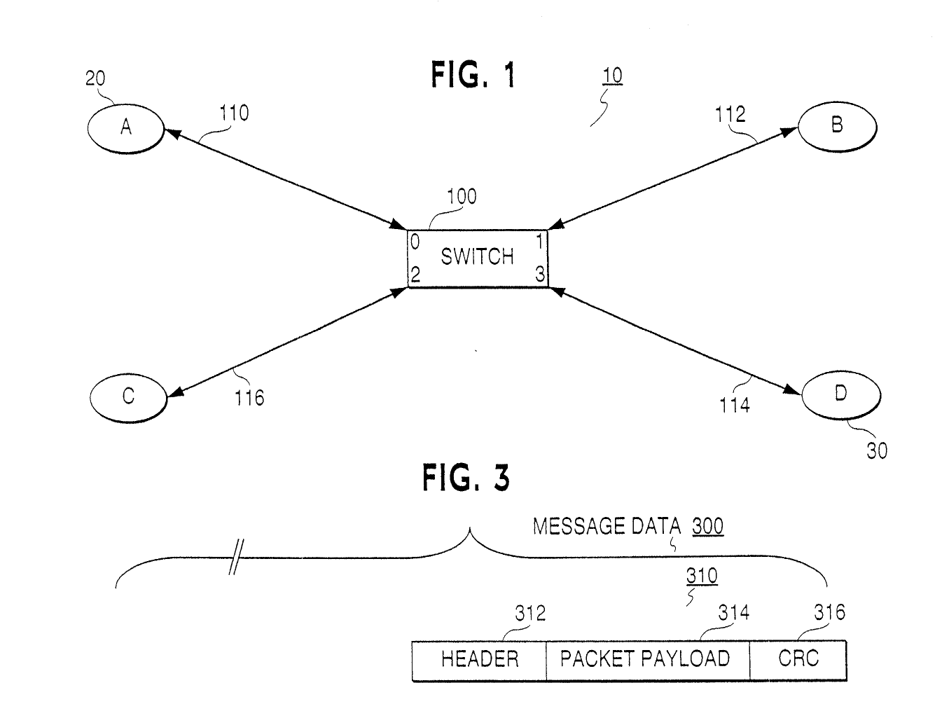

Attention now is directed to the drawings and particularly to FIG. 1, in which a simple data network 10 having several interconnected nodes for data communications according to an embodiment of the present invention is illustrated. As shown in FIG. 1, the data network 10 may include, for example, one or more centralized switches 100 and four different nodes A, B, C, and D. Each node (endpoint) may correspond to one or more I/O units and host systems including computers and/or servers on which a variety of applications or services are provided. I/O unit may include one or more processors, memory, one or more I/O controllers and other local I/O resources connected thereto, and can range in complexity from a single I/O device such as a local area network (LAN) adapter to large memory rich RAID subsystem. Each I/O controller (IOC) provides an I/O service or I/O function, and may operate to control one or more I/O devices such as storage devices (e.g., hard disk drive and tape drive) locally or remotely via a local area network (LAN) or a wide area network (WAN), for example.

The centralized switch 100 may contain, for example, switch ports 0, 1, 2, and 3 each connected to a corresponding node of the four different nodes A, B, C, and D via a corresponding physical link 110, 112, 116, and 114. Each physical link may support a number of logical point-to-point channels. Each channel may be a bi-directional data path for allowing commands and data messages to flow between two connected nodes (e.g., host systems, switch/switch elements, and I/O units) within the data network.

Each channel may refer to a single point-to-point connection where data may be transferred between end nodes (e.g., host systems and I/O units). The centralized switch 100 may also contain routing information using, for example, explicit routing and/or destination address routing for routing data from a source node (data transmitter) to a target node (data receiver) via corresponding link(s), and re-routing information for redundancy.

The specific number and configuration of end nodes (e.g., host systems and I/O units), switches and links shown in FIG. 1 is provided simply as an example data network. A wide variety of implementations and arrangements of a number of end nodes (e.g., host systems and I/O units), switches and links in all types of data networks may be possible.

According to an example embodiment or implementation, the end nodes (e.g., host systems and I/O units) of the example data network shown in FIG. 1 may be compatible with the “Next Generation Input/Output (NGIO) Specification” as set forth by the NGIO Forum on Jul. 20, 1999, and the “InfiniBand™ Architecture Specification” Revision 1 as set forth by the InfiniBand™ Trade Association on Jun. 19, 2001. According to the NGIO/InfiniBand™ Specification, the switch 100 may be an NGIO/InfiniBand™ switched fabric (e.g., collection of links, routers, switches and/or switch elements connecting a number of host systems and I/O units), and the end node may be a host system including one or more host channel adapters (HCAs), or a remote system such as an I/O unit including one or more target channel adapters (TCAs). Both the host channel adapter (HCA) and the target channel adapter (TCA) may be broadly considered as fabric (channel) adapters provided to interface end nodes to the NGIO/InfiniBand™ switched fabric, and may be implemented in compliance with “Next Generation I/O Link Architecture Specification: HCA Specification, Revision 1.0”, and the “InfiniBand™ Specification” and the “InfiniBand™ Link Specification” for enabling the end nodes (endpoints) to communicate to each other over an NGIO/InfiniBand™ channel(s) with data transfer rates, for example, from 2.5 gigabit per second (Gbps), 10 Gbps and 30 Gbps.

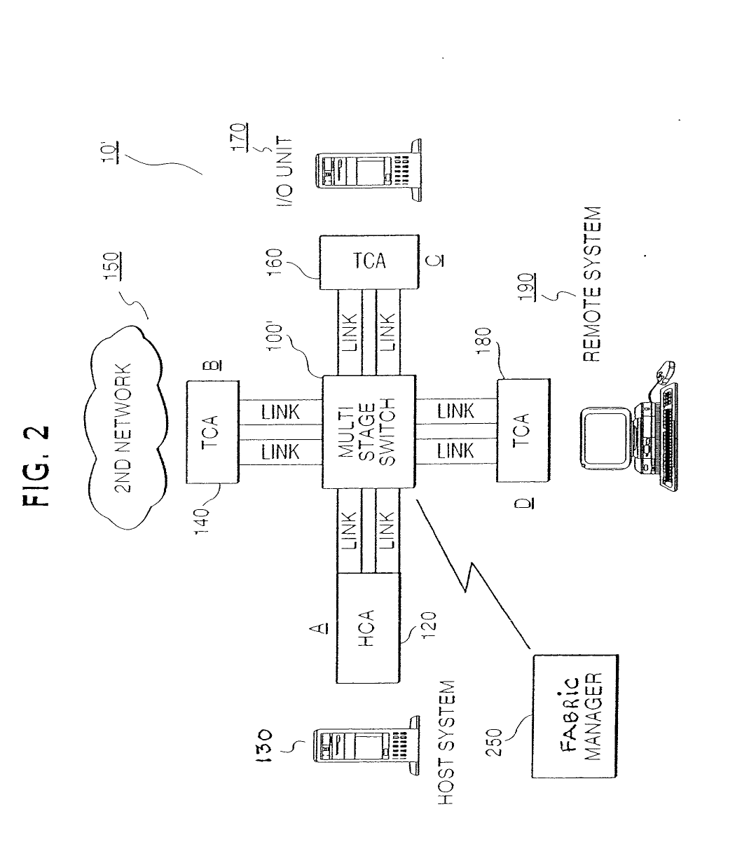

For example, FIG. 2 illustrates an example data network (i.e., system area network SAN) 10′ using an NGIO/InfiniBand™ Architecture to transfer message data from a source node to a destination node according to an embodiment of the present invention. As shown in FIG. 2, the data network 10′ includes an NGIO/InfiniBand™ switched fabric 100′ for allowing a source node and a destination node to communicate to a large number of other nodes over one or more designated channels. Each node may contain work queue formed in pairs, known as Queue Pair (QP), in which service (work) requests are posted by a consumer (independent process or thread of an operating system “OS”) to describe data transfer operations (i.e., send/receive operations and remote direct memory access “RDMA” read/write operations) and location of data to be 1i moved for processing and/or transportation over one or more designated channels via a switched fabric 100′. Each node may also serve as a source (initiator) node which initiates a message data transfer (message send operation) or a target node of a message passing operation (message receive operation). Examples of such a system include host servers providing a variety of applications or services and I/O units providing storage oriented and network oriented IO services. Work requests (data movement operations such as message send/receive operations and RDMA read/write operations) may be posted to queue pairs (QPs) such that one or more channels between communication devices at an end node (host system) or between multiple end nodes connected together directly or via a data network may be created and managed to perform requested operations. A channel connection may be established over a switched fabric 100′ to allow work queue pairs (QPs) at source and destination nodes (e.g., host and remote systems, and IO units that are connected to the switched fabric 100′) to communicate to each other. Each channel can support one of several different connection semantics. Physically, a channel may be bound to a hardware port of a host system. Each channel may be acknowledged or unacknowledged. Acknowledged channels may provide reliable transmission of messages and data as well as information about errors detected at the remote end of the channel. Typically, a single channel between the host system and any one of the remote systems may be sufficient but data transfer spread between adjacent ports can decrease latency and increase bandwidth. Therefore, separate channels for separate control flow and data flow may be desired. For example, one channel may be created for sending request and reply messages. A separate channel or set of channels may be created for moving data between the host system and any one of the remote systems. In addition, any number of end nodes or end stations, switches and links may be used for relaying data in groups of packets between the end stations and switches via corresponding NGIO/InfiniBand™ links. A link can be a copper cable, an optical cable, or printed circuit wiring on a backplane used to interconnect switches, routers, repeaters and channel adapters (CAs) forming the NGIO/InfiniBand™ switched fabric 100′.

For example, node A may represent a host system 130 such as a host computer or a host server on which a variety of applications or services are provided. Similarly, node B may represent another network 150, including, but may not be limited to, local area network (LAN), wide area network (WAN), Ethernet, ATM and fibre channel network, that is connected via high speed serial links. Node C may represent an I/O unit 170, including one or more I/O controllers and I/O units connected thereto. Likewise, node D may represent a remote system 190 such as a target computer or a target server on which a variety of applications or services are provided. Alternatively, nodes A, B, C, and D may also represent individual switches of the NGIO/InfiniBand™ switched fabric 100′ which serve as intermediate nodes between the host system 130 and the remote systems 150, 170 and 190.

Host channel adapter (HCA) 120 may be used to provide an interface between a memory controller (not shown) of the host system 130 (e.g., servers) and a switched fabric 100′ via high speed serial NGIO/InfiniBand™ links. Similarly, target channel adapters (TCA) 140 and 160 may be used to provide an interface between the multi-stage switched fabric 100′ and an I/O controller (e.g., storage and networking devices) of either a second network 150 or an I/O unit 170 via high speed serial NGIO/InfiniBand™ links. Separately, another target channel adapter (TCA) 180 may be used to provide an interface between a memory controller (not shown) of the remote system 190 and the switched fabric 100′ via high speed serial NGIO/InfiniBand™ links. Both the host channel adapter (HCA) and the target channel adapter (TCA) may be broadly considered as channel adapters (CAs) (also known as fabric adapters) provided to interface either the host system 130 or any one of the remote systems 150, 170 and 190 to the switched fabric 100′, and may be implemented in compliance with “Next Generation I/O Link Architecture Specification: HCA Specification, Revision 1.0″ and the “InfiniBand™ Architecture Specification” for enabling the end nodes (endpoints) to communicate on one or more an NGIO/InfiniBand™ link(s). Individual channel adapters (CAs) and switches may have one or more connection points known as ports for establishing one or more connection links between end nodes (e.g., host systems and I/O units). In addition, one or more channel adapters (CA) may be advantageously installed, for example, at a host system 130 to expand the number of ports available for redundancy and multiple switched fabrics.

The multi-stage switched fabric 100′ may include one or more subnets interconnected by routers in which each subnet is composed of switches, routers and end nodes (such as host systems or I/O subsystems). In addition, the multi-stage switched fabric 100′ may include a fabric manager 250 connected to all the switches for managing all network management functions. However, the fabric manager 250 may alternatively be incorporated as part of either the host system 130, the second network 150, the I/O unit 170, or the remote system 190 for managing all network management functions.

If the multi-stage switched fabric 100′ represents a single subnet of switches, routers and end nodes (such as host systems or I/O subsystems) as shown in FIG. 2, then the fabric manager 250 may alternatively be known as a subnet manager “SM”. The fabric manager 250 may reside on a port of a switch, a router, or a channel adapter (CA) of an end node and can be implemented either in hardware or software. When there are multiple subnet managers “SMs” on a subnet, one subnet manager “SM” may serve as a master SM. The remaining subnet managers “SMs” may serve as standby SMs. The master SM may be responsible for (1) learning or discovering fabric (network) topology; (2) assigning unique addresses known as Local Identifiers (LID) to all ports that are connected to the subnet; (3) establishing all possible data paths among end nodes, via switch forwarding tables (forwarding database); and (4) detecting and managing faults or link failures in the network and performing other network management functions. However, NGIO/InfiniBand™ is merely one example embodiment or implementation of the present invention, and the invention is not limited thereto. Rather, the present invention may be applicable to a wide variety of any number of data networks, hosts and I/O units using industry specifications. For example, practice of the invention may also be made with Future Input/Output (FIO). FIO specifications have not yet been released, owing to subsequent merger agreement of NGIO and FIO factions combine efforts on InfiniBand™ Architecture specifications as set forth by the InfiniBand Trade Association (formed Aug. 27, 1999) having an Internet address of“http://www.InfiniBandta.org.”

FIG. 3 illustrates an example packet format of message data transmitted from a source node (data transmitter) to a destination node (data receiver) through switches and/or intermediate nodes in an example IBA subnet according to the “InfiniBand™ Architecture Specification” Revision 1, as set forth by the InfiniBand™ Trade Association on Jun. 19, 2001. As shown in FIG. 3, a message data 300 may represent a sequence of one or more data packets 310 (typically derived from data transfer size defined by a work request). Each packet 310 may include header information 312, variable format packet payload 314 and cyclic redundancy check (CRC) information 316. Under the “Next Generation Input/Output (NGIO) Specification” as previously set forth by the NGIO Forum on Jul. 20, 1999, the same data packets may be referred to as data cells having similar header information as the least common denominator (LCD) of message data. However, NGIO header information may be less inclusive than InfiniBand™ header information. Nevertheless, for purposes of this disclosure, data packets are described herein below via InfiniBand™ protocols but are also interchangeable with data cells via NGIO protocols.

The header information 312 according to the InfiniBand™ specification may include, for example, a local routing header, a global routing header, a base transport header and extended transport headers each of which contains functions as specified pursuant to the “InfiniBand™ Architecture Specification”. For example, the local routing header may contain fields such as a destination local identifier (LID) field used to identify the destination port and data path in the data network 10′, and a source local identifier (LID) field used to identify the source port (injection point) used for local routing by switches within the example data network 10′ shown in FIG. 2.

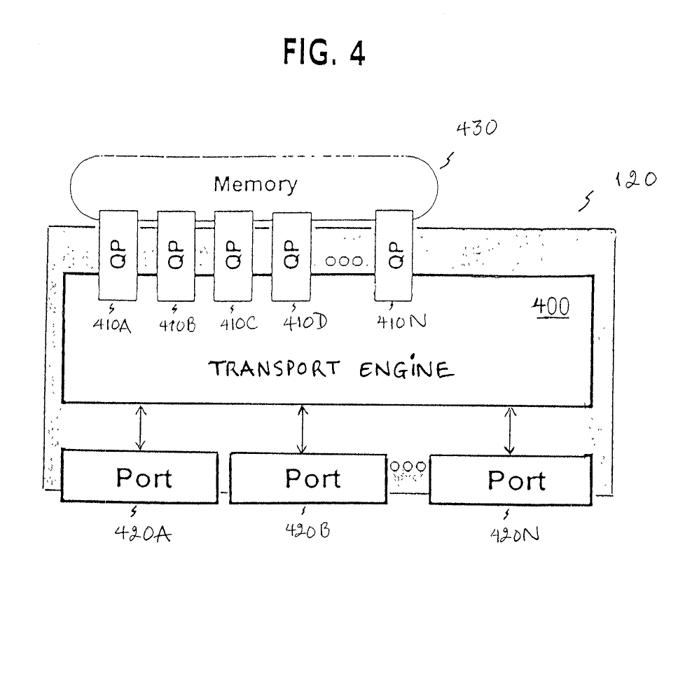

FIG. 4 illustrates an example channel adapter (CA) installed, for example, in a host system to support data transfers via an InfiniBand™ switched fabric according to an embodiment of the present invention. As shown in FIG. 4, the host channel adapter (HCA) 120 may include a programmable transport engine 400 supporting a number of queue pairs (QPs) 410A-410N in which work requests may be posted to describe data movement operation and location of data to be moved for processing and/or transportation via a switched fabric 100′. Such a transport engine 400 may be hardware which resides in a host memory 430 separately from the host channel adapter (HCA) 120, or alternatively, may be software provided as part of kernel-level device drivers (not shown) of a host operating system (OS).

All queue pairs (QPs) may share physical ports 420A-420N into a switched fabric 100′. Each queue pair (QP) includes a send queue (“SQ” for outbound requests) served as an “initiator” which requests, for example, normal message sends, remote direct memory access “RDMA” reads which request messages to be read from specific memory locations of a target system, via a switched fabric 100′, and remote direct memory access “RDMA” writes which request messages to be written onto specific memory locations of a target system, via a switched fabric 100′ as shown in FIG. 4; and a receive queue (“RQ” for inbound requests) served as a “responder” which receives requests for messages from normal sends, RDMA reads and RDMA writes from a target system, via a switched fabric 100′ as shown in FIG. 4. For each port, there may be two special QPs (QP0 and QP1) configured for management and all other QPs configured for operation through a particular port.

The host channel adapter (HCA) 120 may also have multiple ports 420A-420N to access the switched fabric 100′ as shown in FIG. 4. Each port may be assigned a local ID (LID) or a range of LIDs. Each port has its own set of transmit and receive buffers (FIFOs) utilized to send and receive data messages, via the switched fabric 100′ as shown in FIG. 4.

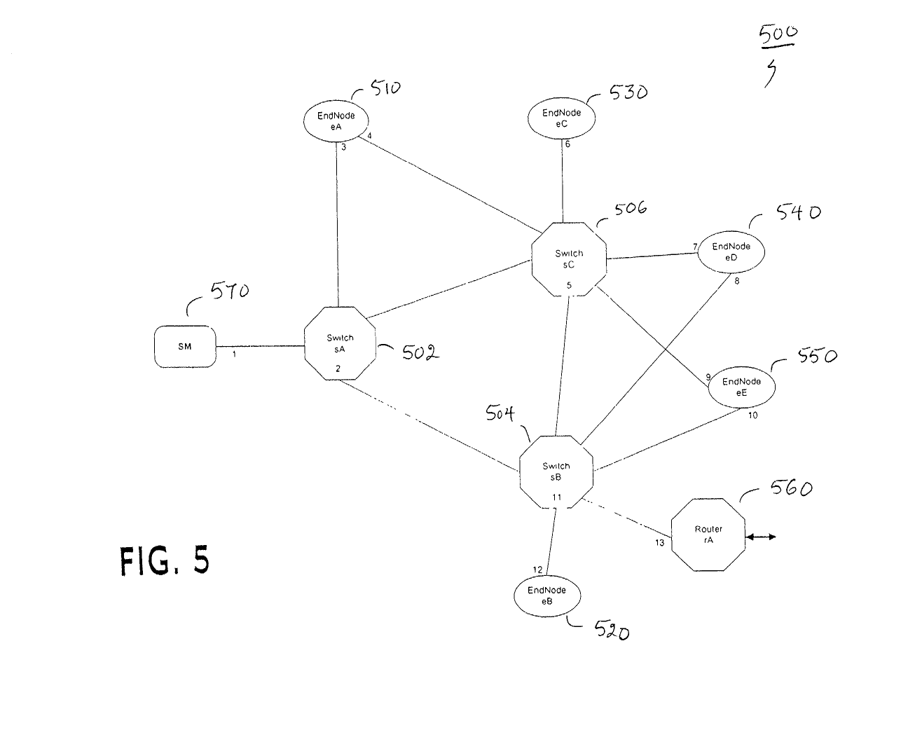

Turning now to FIG. 5, an example InfiniBand™ Architecture (IBA) subnet in an InfiniBand™ cluster including, but not limited thereto, five (5) end nodes (eA) 510, (eB) 520, (eC) 530, (eD) 540, and (eE) 550 including one or more channel adapters (not shown), a router (rA) 560 and a subnet manager (SM) 570 according to an embodiment of the present invention is illustrated. Router (rA) 560 may be used as an interconnect to one or more IBA subnets to form a switched fabric 100′ as shown in FIG. 4. Each end node (eA) 510, (eB) 520, (eC) 530, (eD) 540, and (eE) 550 may serve as an individual service provider or an individual InfiniBand™ client requesting services from the service provider in a client/server model, for example. One or more channel adapters (CAs) may be installed at each end node (eA) 510, (eB) 520, (eC) 530, (eD) 540, and (eE) 550.

The IBA subnet 500 may also include a collection of switch (sA) 502, switch (sB) 504, and switch (sC) 506 arranged to establish connection between the end nodes 510, 520, 530 and 540, via respective channel adapters (CAs). Each switch as well as the channel adapter (CA) may have one or more connection points called “ports” provided to establish connection with every other switch and channel adapter (CA) in an example IBA subnet 500 via one or more link.

Typically IBA management services may be provided by the local subnet manager “SM” 570. The subnet manager “SM” 570 may substitute the fabric manager 250 shown in FIG. 2, and can be implemented either in hardware or software module (i.e., an application program) installed to provide IBA management services for all switches and end nodes in the IBA subnet 500. For example, if the subnet manager “SM” 570 is implemented in software, a subnet management access module may be written using high-level programming languages such as C, C++ and Visual Basic, and may be provided on a computer tangible medium, such as memory devices; magnetic disks (fixed, floppy, and removable); other magnetic media such as magnetic tapes; optical media such as CD-ROM disks, or via Internet downloads, which may be available for a human subnet (fabric) administrator to conveniently plug-in or download into an existing operating system (OS). Alternatively, the software access module may also be bundled with the existing operating system (OS) which may be activated by a particular device driver for performing all network management functions in compliance with the InfiniBand™ Architecture specification.

In one embodiment of the present invention, the subnet manager “SM” 570 may be installed at any one of the end nodes (eA) 510, (eB) 520, (eC) 530, (eD) 540, and (eE) 550 or the switches (sA) 502, (sB) 504, and (sC) 506 for managing all subnet management functions. However, the subnet manager “SM” 570 may also be installed as part of any individual end node and switch within the IBA subnet 500 as shown in FIG. 5.

The IBA management services may be broadly classified into subnet services and general services. At a minimum the subnet services, offered by the subnet manager “SM” 570, include basic initialization such as discovering fabric topology, assigning unique addresses called Local Identifiers (LID) to all ports that are connected to the IBA subnet 500, programming switch forwarding tables (also known as routing table) and maintaining general functioning of the IBA subnet 500. Most of the data collected during discovery and used to configure the IBA subnet 500 may then be assimilated for a subnet administration service to provide access to information such as data paths and alternate data paths between end nodes, topology change notifications and notification of events, including error detection, and recovery procedures.

General Services may include, for example, a communication management service which provides the means to set up and manage communications between a pair of queue pairs (QP) or, in certain cases, to identify which queue pair (QP) to use for a certain service; a performance management service which specifies a set of facilities for examining various performance characteristics of the IBA subnet 500; a device management service which specifies the means for determining the type and location of various types of fabric-attached devices such as I/O controllers; a device configuration service which assigns fabric-attached devices such as I/O controllers to hosts; a baseboard management service which allows management of fabric-attached devices beyond a channel adapter (CA); and a network protocol service which specifies mechanisms to support transport of protocol operations such as Simple Network Management Protocol “SNMP” operations through the IBA subnet 500.

In addition, particular cluster implementations may also need and contain proprietary services to perform cluster-specific functions. For example, specific cluster implementations may contain a Name Service that maps host system names to InfiniBand™ information such as Local Identifiers (LIDs), Global Identifiers (GIDs), Globally Unique Identifiers (GUIDs) etc.

Each of these IBA management services may be implemented as logically independent entities, referred to as Managers and Agents, and Interfaces. Managers may be conceptual functional entities that effect control over IBA fabric-attached devices (or elements) or provide for gathering information from IBA fabric-attached devices. In general, managers may reside anywhere in the IBA subnet 500 (or switched fabric 100′). Similarly, agents may be conceptual functional entities present in IBA channel adapters (CAs), switches, and routers that process management messages arriving at the port of the IBA channel adapters (CAs), switches, and routers where they exist. Interfaces may represent a target (for example, queue pairs “QPs”) to which data messages may be sent and through which data messages will be processed or will be dispatched to an appropriate processing entity. Management operations may be divided into a set of management service classes. For a given class of activity, there is usually only a small number of managers on an IBA subnet 500 as shown in FIG. 5. Conceptually, of each supported service class, there may be one agent on each switch, channel adapter (CA), and router on the IBA subnet 500 as shown in FIG. 5.

Communication between Managers and Agents may be performed through management messages referred to as Management Datagrams (MADs). Management Datagrams (MADs) are the basic elements of the message scheme defined for management communications. MADs may be classified into predefined management classes and for each MAD there may be a specified format, use, and behavior according to the InfiniBand™ Architecture specification.

In addition, the IBA management services including the subnet services and the general services may also be assigned by Management Datagram classes (MAD classes). For example, the subnet administration service may be assigned MAD class 3, the device management service may be assigned MAD class 6, SNMP service may be assigned MAD class 8 etc. For each service, there are typically service managers, called Class Managers for the MAD class and service agents, called Class Agents for the MAD class. Class agents and class managers communicate with each other using messages of the MAD class assigned to that service.

According to the InfiniBand™ Architecture specification, the subnet services use a special class of Management Datagram (MAD) called a Subnet Management Packet (SMP) which is directed to a special queue pair (QP0). Likewise, general services use another class of Management Datagram (MAD) called a General Management Packet (GMP) which is directed to a special queue pair (QP1) called the General Service Interface (GSI). GMPs are sent by class agents across different nodes of the IBA subnet 500 to manage the switched fabric 100′ as shown in FIG. 4. Some of the class agents/managers include the Subnet Administrator (SA), Name Services Manager, IO Resource Manager, Communications Manager, Performance Manager and Device Manager.

SMPs can be sent and received based on the subnet manager (SM) queries or be forwarded as traps and notices. Likewise, GMPs may be sent and received by the various class managers or be forwarded as traps and notices by mechanisms currently defined in the InfiniBand™ Architecture specification.

QP0 and QP1 are unreliable datagram (UD) queue pairs used for subnet management purposes and hence, are commonly referred to as “management QPs”. QP0 may be managed by the agent of subnet services, known as Subnet Management Agent (SMA). Similarly, QP1 may be managed by the agent of general services, known as General Services Agent (GSA). The SMA and GSA are required to exist on each active port of the channel adapter (CA). The SMA and GSA may have multiple InfiniBand™ clients that sit on top and use the services of the SMA and GSA to receive incoming messages and send outgoing messages. All SMP messages sent/received on behalf of the SMA and all its clients are done through a single QP—the SMI QP0. All GMP messages sent/received on behalf of the GSA and all its clients are done through a single QP—the GSI QP1. At any time, these queue pairs (QP0 and QP1) can receive more than one MAD. As per the InfiniBand™ Architecture specification, any time an incoming data message arrives at a QP, a receive buffer must be posted for that data message. If there is none, the incoming data message is dropped. Since the InfiniBand™ Architecture specification does not define hardware end-to-end flow-control for unreliable datagrams, incoming data messages can arrive even when no receive buffers are posted and the hardware can drop any incoming data messages (datagrams) if there are insufficient receive buffers posted.

Each management QP (QP0 or QP1) can have multiple clients wanting to send and receive data messages from that QP. For example, QP1 may be used simultaneously to send/receive messages from the Subnet Administrator (SA), the Name Services Manager, the I/O Resource Manager, Communications Manager, Performance Manager, Device Manager, and SNMP agent etc. This means that the General Services Agent (GSA) managing QP1 must be able to post enough receive buffers such that data messages destined for any of its local clients are not dropped due to lack of receive buffers. However, the General Services Agent (GSA) has no idea of the traffic pattern of its clients, and does not know or control whether incoming traffic for each client will be light or heavy, how the traffic pattern will vary over time and when to expect bursts of traffic. Therefore, the General Services Agent (GSA) does not have enough information to make an informed decision about how many receive buffers to post in order to receive the incoming data messages.

The InfiniBand™ Architecture specification does not define any feedback mechanism by which a client of the General Services Agent (GSA) can indicate its expected traffic pattern to the General Services Agent (GSA) or indicate when it expects a burst of incoming data messages.

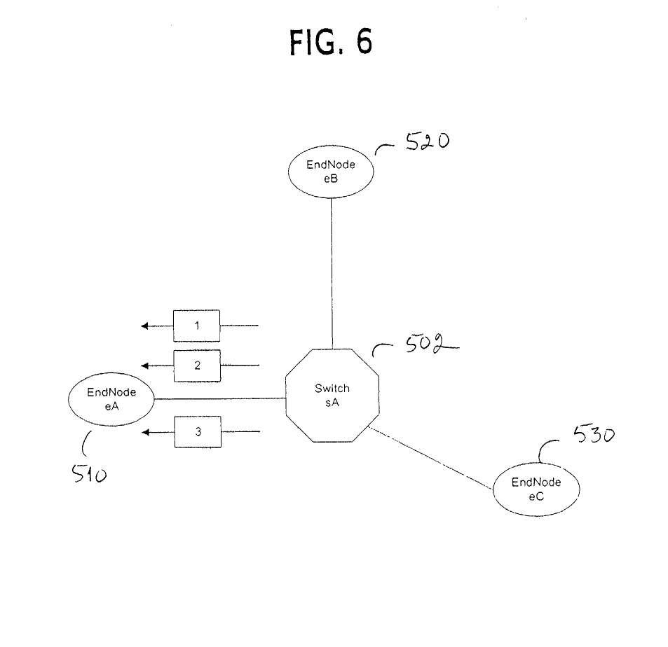

For example, as shown in FIG. 6, at end node (eA) 510, data messages #1, #2 and #3 may arrive at the same end point in time. These data messages may have arrived either from the same node eA (through local loopback) or from the other nodes (eB) 520 and (eC) 530, via switch (sA) 502. SMPs and GMPs may be received at different time intervals based on the logic of the agents that govern the traffic. If the receive side of the UD queue pair (QP) has no pre-posted buffer, the datagram will be dropped by the hardware. In addition, there may a burst of datagram traffic at any time on the IBA subnet 500 as shown in FIG. 5. This may occur when more than one agent is sending data messages to the same destination or multiple nodes sending data messages to the same destination or both. A typical example may be the first time an IBA subnet 500 gets activated, General Services Agents (GSAs) on all nodes will query the Subnet Administrator (SA) on the Subnet Manager (SM) node for respective properties and path records to other fabric-attached agents. If the IBA subnet 500 as shown in FIG. 5 is large, data messages (packets) may very be easily dropped at the destination QP1. However, if there is a feedback loop, the subnet administrator may expect an incoming traffic burst immediately after subnet initialization and indicate to the local General Services Agent (GSA) to post a large number of receive buffers on its behalf on QP1.

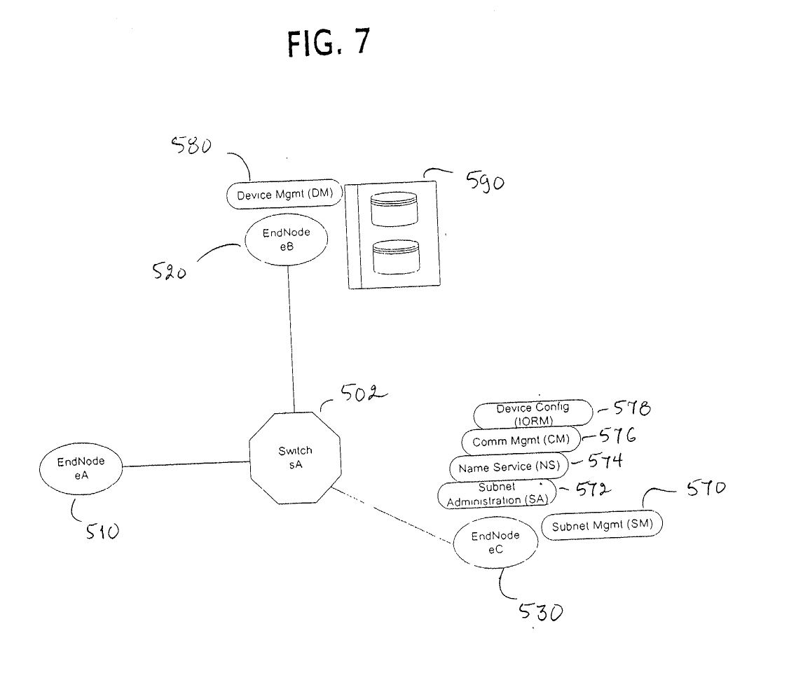

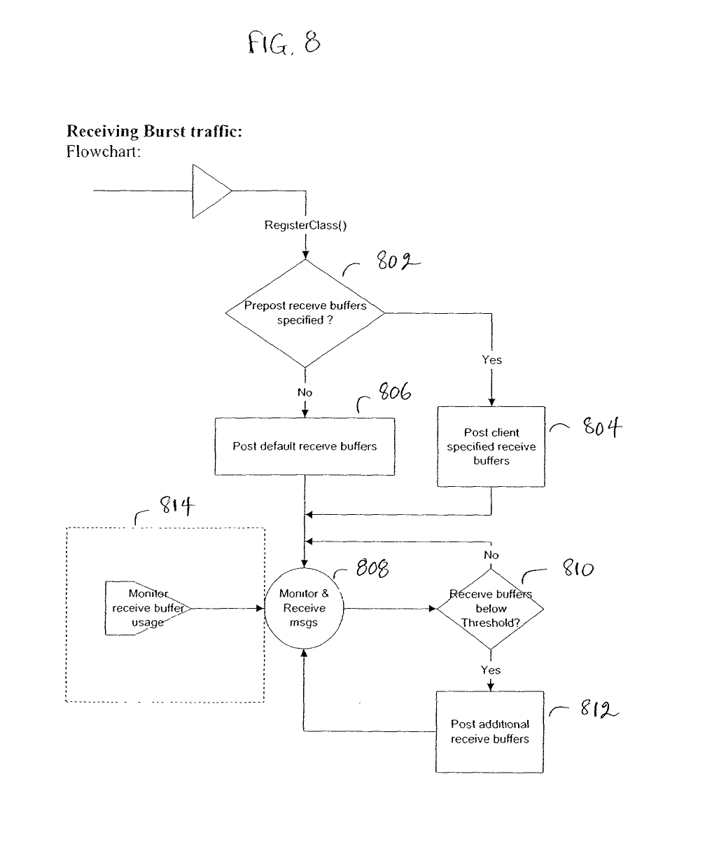

Moreover, in an IBA subnet 500, one or more class agents may also exchange datagrams using MADs. The class agents may reside on different ports on different channel adapters (CAs) installed at end nodes in an IBA subnet 500 or be located on the same port and same channel adapter (CA). For example, FIG. 7 provides an overview of management agents in an IBA subnet 500 shown in FIG. 5. As shown in FIG. 7, the Subnet Manager (SM) 570 and class agents such as Subnet Administrator (SA) 572, Name Services Manager 574, Communication Manager 576, and 10 Resource Manager (IORM) 578 may be installed at the same port and end node (eC) 530, while a class agent such as the Device Manager 580 supporting I/O controllers 590 may be the only agent installed on end node (eB) 520.

If the IBA subnet 500 as shown in FIGS. 5 and 7 is expanded with multiple end nodes such as end node (eB) 520, there may be times where all these end nodes such as end node (eB) 520 will at some point in time send data messages (datagrams) to end node (eC) 530. These datagrams may be query requests or responses to queries that were previously instantiated by the subnet management node (eC) 530. Since these multiple agents use one well known queue pair (QP) such as QP1 to exchange data, the channel adapter (CA) installed at end node (eC) 530 will drop most of the incoming data messages (datagrams) on QP1 if there are insufficient receive buffers pre-posted. Also the General Services Agent (GSA) which manages QP1 will not be aware of these incoming requests and may pre-post only one datagram on the receive queue pair (QP) at any time. This can lead to frequent message drops and amount to retries of these send operation on the remote nodes.

If datagram packets are dropped at the destination node, class agents that sent the initial queries may retry the operation at a later point in time. However, retry mechanisms can be very expensive since a lot of operating system resources are required. In addition, a lot of datagrams can be dropped on the various UD queue pairs (QP) in an IBA subnet 500 at any time if the load is high. A load may be termed “high” if the destination node that receives the data messages spends most of its time in processing these datagrams that arrive on its receive queue. Moreover, if a request does not get a reply, retry mechanisms typically implemented in software to resend the previous failed request require a lot of system resources both in system time and resources as well as in software. Furthermore, multiple retries from multiple agents located on different end nodes may result in consuming a sizable portion of the subnet bandwidth which may also slow down processes and applications that derive functionality based on these agents.

In order to reduce, if not eliminate, dropped messages and the number of retries on the end nodes as well as to enhance the functionality of end nodes in system resources and complexity of software implementation, a feedback mechanism is created and incorporated into any end node, for example, (eA) 510, (eB) 520, (eC) 530, (eD) 540, or (eE) 550 of an IBA subnet 500 to provide feedback from clients of the InfiniBand™ management QPs to the SMA and GSA regarding client requirements for receive buffers to handle bursty traffic and leads to far fewer dropped messages. According to an embodiment of the present invention, the feedback mechanism may be implemented at a subnet management (SM) node such as end node (eC) 530 of an IBA subnet 500 as well as a non subnet management (SM) node such as end node (eA) 510 to determine the optimal number of receive buffers to post for GSA and SMA clients (local or remote). Such a feedback mechanism may include an algorithm executed by the host node when an incoming data message is received from the switched fabric. The algorithm may be software written by high-level programming languages such as C, C++ and Visual Basic, and may be provided on a computer tangible medium, such as memory devices; magnetic disks (fixed, floppy, and removable); other magnetic media such as magnetic tapes; optical media such as CD-ROM disks, or via Internet downloads, which may be available for a human fabric administrator to conveniently plug-in or download into an existing operating system (OS) of the host node. Alternatively, the software module may also be bundled with the existing operating system (OS) which may be activated when an incoming data message is received from a client in compliance with the InfiniBand™ Architecture specification. As a result, the fabric bandwidth required for management traffic and fabric congestion can be reduced significantly. Likewise, the client overhead involved in processing dropped messages and re-sending management datagrams can also be reduced.

According to an embodiment of the present invention, a feedback mechanism seeks to assign the following responsibility to the General Services Agents (GSA), the Subnet Management Agent (SMA) or any other entity that manages the management queue pair (QP) on behalf of one or more clients on the same management QP (QP0 and QP1) at an end node of an IBA subnet 500. For purposes of brevity, only the General Services Agent (GSA) and related functionality will be described as follows:

1. The General Services Agent (GSA) must post a minimum number of receive buffers per client. This minimum value must be tunable by the human fabric administrator. The default value may be calculated by assuming a certain standard subnet size and traffic pattern. For example, the General Services Agent (GSA) may assume that each active channel adapter (CA) port on the IBA subnet 500 (or switched fabric 100′) will need one (1) receive buffer per GSA client. As an example, the General Services Agent (GSA) may then assume that under most normal operating conditions, there will be sixteen (16) active channel adapter ports on the IBA subnet 500. In this example, the default value of the number of receive buffers to post per local QP1 client will be sixteen (16). This default value must be tunable by the human fabric administrator so that the default value can be over-ridden with a value that is more appropriate for the operating conditions of the IBA subnet 500 (or switched fabric 100′).

2. The General Services Agent (GSA) must post additional receive buffers each time a new local client registers with it to use the QP1. The General Services Agent (GSA) can use the current value of number of receive buffers per client as described above (that is, “16” receive buffers per local Q1 client) to determine how many additional receive buffers to post each time a new client registers.

3. The General Services Agent (GSA) must also allow its clients to dynamically increase and decrease the number of receive buffers posted on its behalf. This means that at the time of client registration, the General Services Agent (GSA) must allow its client to optionally specify how many receive buffers to post on its behalf. If a client specifies a value, this value may over-ride the static default value tuned by the human fabric administrator. If the client does not specify a value, the static default value may be used at the time of client registration. In addition, the General Services Agent (GSA) must support an additional programming interface that allows a client to dynamically specify additional receive buffers to be posted or removed. This allows a client to handle anticipated bursts of incoming traffic correctly. Once the anticipated burst is over, the client may make an additional call to reduce the number of receive buffers posted on its behalf by the General Services Agent (GSA) so that resources are not wasted unnecessarily.

4. The General Services Agent (GSA) must automatically post additional receive buffers once the number of posted receive buffers dips below a threshold value. This happens independent of the client requests for more receive buffers. The threshold value must be tunable by the human fabric administrator. The default value of this threshold may take into account the number of local clients registered with the General Services Agent (GSA). This means that an automatic posting algorithm in the General Services Agent (GSA) may be triggered early if there are more clients using the same QP and may kick in later if there are fewer clients. The General Services Agent (GSA) must remove the additional receive buffers it automatically posted once the number of posted buffers goes up above an upper threshold value so that resources are not wasted unnecessarily. This threshold value must also be tunable by the human fabric administrator.

5. As an additional step, the General Services Agent (GSA) may monitor the pattern of incoming traffic for specific clients and react appropriately based on current traffic conditions. For example, if the General Services Agent (GSA) consistently receives a large number of incoming data messages for a specific client and this client has requested only a small number of receive buffers, the General Services Agent (GSA) can increase the number of receive buffers posted on behalf of this client. The General Services Agent (GSA) can also optionally provide feedback to the client indicating that the client has miscalculated (or not communicated) its receive buffer needs.

6. As an additional step, the General Services Agent (GSA) may attempt to introduce a degree of fairness in the usage of its receive buffer pool. Since the General Services Agent (GSA) has a single common receive buffer pool between all clients, it is possible that one or more (misbehaving) clients are using up receive buffers intended to be used by other clients. This can happen if a (misbehaving) client gets far more data messages than the number of receive buffers posted on its behalf. The General Services Agent (GSA) can automatically attempt to increase the number of receive buffers posted on behalf of this client. However, the General Services Agent (GSA) may eventually run out of memory and may not be able to post additional receive buffers in its buffer pool. In this situation, the General Services Agent (GSA) can attempt to enforce appropriate quotas to receive buffer usage by its clients. For example, the General Services Agent (GSA) may allow a specific client only to receive a number of data messages equal to the number of receive buffers posted on its behalf. If additional data messages arrive for that client, the General Services Agent (GSA) may discard the data messages as soon as it becomes aware that the data messages exceed the message/buffer quota allocated to this client. In this way, receive buffers allotted to other clients are not used up by this client and other (well behaved) clients are not penalized due to the extra traffic arriving for this single client that shares the same buffer pool.

As previously indicated, the same procedure applies to the Subnet Management Agent (SMA) and to any other entity that manages multiple clients on the same Unreliable Datagram QP. These clients may be local or remote Subnet Administrator (SA), Name Services Manager, the I/O Resource Manager, Communications Manager, Performance Manager, Device Manager, and SNMP agent depending on the implementation.

FIG. 8 illustrates an example procedure of a feedback mechanism executed by a General Services Agent (GSA) or a Subnet Management Agent (SMA) according to an embodiment of the present invention. The algorithm includes steps executed at client registration time, in addition to steps executed in response to incoming data messages. As shown in FIG. 8, when a client registers with the GSA, the host node (eC) 530 identifies the service class associated with the data messages and determines, by way of the General Services Agent (GSA), if there are a number of pre-post receive buffers specified for a particular client at block 802. The data messages received at the host node (eC) 530 may come from a different end node or multiple end nodes such as end node (eA) 510, (eB) 520, (eD) 540, and (eE) 550 in an example IBA subnet 500 shown in FIG. 5. The number of receive buffers are pre-posted by the General Services Agent (GSA) per client, and are tunable by a human fabric administrator.

If there are a number of pre-post receive buffers specified for that client, the General Services Agent (GSA) posts the client specified receive buffers at the management queue pair (QP1) to receive the incoming data messages at block 804. However, if no pre-post receive buffers are specified for that client, the General Services Agent (GSA) posts a default number of receive buffers (default receive buffers) at the management queue pair (QP1) to receive the incoming data messages at block 806. For example, the default number of receive buffers posted per client may be sixteen (16).

Next, the General Services Agent (GSA) continues to monitor and receive additional incoming data messages at block 808, and determines if the number of posted receive buffers dips below a threshold value at block 810. If the number of posted receive buffers dips below a threshold value, the General Services Agent (GSA) posts additional receive buffers at block 812. The General Services Agent (GSA) may remove the additional receive buffers posted once the number of receive buffers posted exceeds an upper threshold value so that the node resources are not wasted unnecessarily.

Optionally, the General Services Agent (GSA) may monitor the receive buffer usage for a particular client and react appropriately based on current traffic conditions at block 814. For example, if a large number of incoming data messages for a specific client are received and the specific client has only requested a small number of receive buffers, the General Services Agent (GSA) can increase the number of receive buffers posted on behalf of this client. Likewise, the General Services Agent (GSA) can automatically attempt to increase the number of receive buffers posted on behalf of a client if that client gets far more data messages than the number of receive buffers posted on its behalf.

As described from the foregoing, the present invention advantageously provides a mechanism which optimizes the number of receive buffers posted for GSA and SMA clients in order to receive incoming data messages intended for specific clients on a particular host node. As a result of the procedure as described with reference to FIGS. 5-8, retries may be totally eliminated or reduced by a sizable number on the end nodes which will benefit the end nodes in terms of system resources and complexity of software implementation. The subnet bandwidth will then be made free for other data operations and thereby free up subnet resources on channel adapters (CAs), switches and routers. Event support is important for designing scalable solutions. Another feature of this procedure is that it fits in the regular GSA model very cleanly and does not require changes in GSA clients. All the complexity is hidden in the GSA and implemented just once rather than forcing each GSA client to incorporate additional complexity to support this capability. This makes the code for GSA and SMA clients less complex and less error prone and simplifies the task of writing GSA and SMA clients. As a result, InfiniBand clusters are more usable, client friendly and less wastefully congested. These properties assist in achieving the end result of a functional and high performance cluster and promote the use of clusters based on NGIO/InfiniBand™ technology.

While there have been illustrated and described what are considered to be exemplary embodiments of the present invention, it will be understood by those skilled in the art and as technology develops that various changes and modifications may be made, and equivalents may be substituted for elements thereof without departing from the true scope of the present invention. For example, the data network as shown in FIGS. 1-4 may be configured differently or employ some or different components than those illustrated. Such a data network may include a local area network (LAN), a wide area network (WAN), a campus area network (CAN), a metropolitan area network (MAN), a global area network (GAN) and a system area network (SAN), including newly developed computer networks using Next Generation I/O (NGIO) and Future I/O (FIO) and Server Net and those networks which may become available as computer technology advances in the future. LAN system may include Ethernet, FDDI (Fiber Distributed Data Interface) Token Ring LAN, Asynchronous Transfer Mode (ATM) LAN, Fiber Channel, and Wireless LAN. However, the mechanism shown in FIGS. 5-6 for allowing multiple entities to handle messages of the same management service class in those clusters may need to be adjusted accordingly. The algorithm shown in FIG. 6 may be configured differently or employ some or different components than those illustrated without changing the basic function of the invention. In addition, storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; and optical media such as CD-ROM disks. Many modifications may be made to adapt the teachings of the present invention to a particular situation without departing from the scope thereof Therefore, it is intended that the present invention not be limited to the various exemplary embodiments disclosed, but that the present invention includes all embodiments falling within the scope of the appended claims.

What is claimed is:

1. A method for managing an incoming data message at a host node in a switched fabric, comprising:
determining whether if there are pre-post receive buffers specified for a client upon registration by the client;
if there are pre-post receive buffers specified for the client, posting client specified receive buffers at management queue pairs (QPs) to receive the incoming data message; and
if no pre-post receive buffers are specified for the client, posting a default number of receive buffers at the management queue pairs (QPs) to receive the incoming data message.

2. The method as claimed in claim 1, further comprising:
continuing to monitor and receive incoming data messages, and determining if the number of posted receive buffers falls below a threshold value; and
if the number of posted receive buffers falls below the threshold value, posting additional receive buffers to receive the incoming data messages.

3. The method as claimed in claim 2, further comprising:
if the number of posted receive buffers exceeds an upper threshold value, removing a designated number of receive buffers posted to receive the additional incoming data messages so as to conserve resources.

4. The method as claimed in claim 3, further comprising:
monitoring a receive buffer usage of the client based on the number of incoming data messages received for the client are received; and
increasing the number of receive buffers posted on behalf of the client to receive the number of incoming data messages intended for the client.

5. The method as claimed in claim 2, wherein the default value of number of receive buffers is set by a fabric administrator based on operating conditions of the switched fabric, including a fabric size and a traffic pattern.

6. The method as claimed in claim 2, wherein the threshold value is set by a fabric administrator based on operating conditions of the switched fabric, including a number of local clients registered at the host node in the switched fabric.

7. The method as claimed in claim 2, wherein the management queue pairs (QP) are unreliable datagram (UD) queue pairs, including QP0 managed by an agent of subnet services, known as Subnet Management Agent (SMA), and QP1 managed by the agent of general services, known as General Services Agent (GSA), in accordance with the “InfiniBand™ Architecture Specification”.

8. A host system comprising:
at least one channel adapter (CA) including one or more ports to support data transfers, via a subnet; and
an access module including a General Services Agent (GSA) and a Subnet Management Agent (SMA) to enable one or more entities to send and receive data messages of management services on the host system, via the subnet, including to determine an optimal number of receive buffers to post at management queue pairs (QPs) so as to receive an incoming data message from the subnet.

9. The host system as claimed in claim 8, wherein one of the General Services Agent (GSA) and the Subnet Management Agent (SMA) is configured to:
determine whether if there are pre-post receive buffers specified for a client upon registration by the client;
if there are pre-post receive buffers specified for the client, post client specified receive buffers at the management queue pairs (QPs) to receive the incoming data message; and
if no pre-post receive buffers are specified for the client, post a default number of receive buffers at the management queue pairs (QPs) to receive the incoming data message.

10. The host system as claimed in claim 9, wherein one of the General Services Agent (GSA) and the Subnet Management Agent (SMA) is further configured to:
monitor and receive incoming data messages, and determine if the number of posted receive buffers falls below a threshold value; and
if the number of posted receive buffers falls below the threshold value, post additional receive buffers to receive the incoming data messages.

11. The host system as claimed in claim 10, wherein one of the General Services Agent (GSA) and the Subnet Management Agent (SMA) is further configured to remove a designated number of receive buffers posted to receive the additional incoming data messages so as to conserve resources, if the number of posted receive buffers exceeds an upper threshold value.

12. The host system as claimed in claim 11, wherein one of the General Services Agent (GSA) and the Subnet Management Agent (SMA) is further configured to monitor a receive buffer usage of the client based on the number of incoming data messages received for the client are received, and increase the number of receive buffers posted on behalf of the client to receive the number of incoming data messages intended for the client.

13. The host system as claimed in claim 10, wherein the default value of number of receive buffers is set by a fabric administrator based on operating conditions of the subnet, including a subnet size and a traffic pattern.

14. The host system as claimed in claim 10, wherein the threshold value is set by a fabric administrator based on operating conditions of the subnet, including a number of local clients registered at the host system in the subnet.

15. The host system as claimed in claim 10, wherein the management queue pairs (QP) are unreliable datagram (UD) queue pairs, including QP0 managed by the Subnet Management Agent (SMA), and QP1 managed by the General Services Agent (GSA), in accordance with the “InfiniBand™ Architecture Specification”.

16. The host system as claimed in claim 10, wherein the management services include a subnet administration service which provides data path information to reach fabric-attached devices; a communication management service which provides the means to set up and manage communications between queue pairs (QP); a performance management service which specifies a set of facilities for examining various performance characteristics of the subnet; a device management service which specifies the means for determining the type and location of various types of fabric-attached devices; a device configuration service which assigns fabric-attached devices to the host system; a baseboard management service which allows management of the fabric-attached devices; and a network protocol service which specifies mechanisms to support transport of Simple Network Management Protocol “SNMP” operations through the subnet.

17. A computer readable medium comprising instructions that, when executed by a host system in a switched fabric including end nodes and switches interconnected via links, cause the host system to determine an optimal number of receive buffers to post at management queue pairs (QPs) by performing the steps of:
determining whether if there are pre-post receive buffers specified for a client upon registration by the client;
if there are pre-post receive buffers specified for the client, posting client specified receive buffers at management queue pairs (QPs) to receive the incoming data message; and
if no pre-post receive buffers are specified for the client, posting a default number of receive buffers at the management queue pairs (QPs) to receive the incoming data message.

18. The computer readable medium as claimed in claim 17, further comprising instructions that, when executed by the host system, cause the host system to further perform the steps of:
continuing to monitor and receive incoming data messages, and determining if the number of posted receive buffers falls below a threshold value; and
if the number of posted receive buffers falls below the threshold value, posting additional receive buffers to receive the incoming data messages.

19. The computer readable medium as claimed in claim 18, further comprising instructions that, when executed by the host system, cause the host system to remove a designated number of receive buffers posted to receive the additional incoming data messages so as to conserve resources, if the number of posted receive buffers exceeds an upper threshold value.

20. The computer readable medium as claimed in claim 18, further comprising instructions that, when executed by the host system, cause the host system to monitor a receive buffer usage of the client based on the number of incoming data messages received for the client are received, and increase the number of receive buffers posted on behalf of the client to receive the number of incoming data messages intended for the client.

21. The computer readable medium as claimed in claim 18, wherein the default value of number of receive buffers is set by a fabric administrator based on operating conditions of the switched fabric, including a fabric size and a traffic pattern.

22. The computer readable medium as claimed in claim 18, wherein the threshold value is set by a fabric administrator based on operating conditions of the switched fabric, including a number of local clients registered at the host node in the switched fabric.

23. The computer readable medium as claimed in claim 18, wherein the management queue pairs (QP) are unreliable datagram (UD) queue pairs, including QP0 managed by an agent of subnet services, known as Subnet Management Agent (SMA), and QP1 managed by the agent of general services, known as General Services Agent (GSA), in accordance with the “InfiniBand™ Architecture Specification”.
